(19) United States
(12) Patent Application Publication
(10) Pub. No.: US 2020/0167060 A1
(43) Pub. Date: May 28, 2020

(54) METHOD, DEVICE, AND COMPUTER PROGRAM FOR DISPLAYING AN ICON

(71) Applicant: Samsung Electronics Co., Ltd., Suwon-si (KR)

(72) Inventor: Lina SUN, Tianjin (CN)

(21) Appl. No.: 16/692,457

(22) Filed: Nov. 22, 2019

(30) Foreign Application Priority Data
Nov. 23, 2018 (CN) 201811407645.1

(51) Int. Cl. G06F 3/0481; G06F 3/0484; G06F 3/0488

(52) U.S. Cl. CPC G06F 3/04817; G06F 3/04883; G06F 3/04847

(57) ABSTRACT

An electronic device for displaying a user interface and a method therefor are provided. The electronic device includes a memory storing instructions, and at least one processor configured to execute the instructions to display, in a partial area of a graphic user interface, a first graphic representation of a function in the electronic device, identify a value corresponding to the function in the electronic device, display, in the partial area, a second graphic representation of the function based on the identified value. The first graphic representation is different from the second graphic representation, and a display of the first graphic representation and a display of the second graphic representation alternate with each other in the partial area in response to receiving one or more user inputs on the first graphic representation and the second graphic representation.

### CROSS-REFERENCE TO RELATED APPLICATION(S)

This application is based on and claims priority under 35 U.S.C. § 119 of a Chinese patent application number 201811407645.1 filed on Nov. 23, 2018, in the Chinese Patent Office, the disclosure of which is incorporated by reference herein in its entirety.

### BACKGROUND

### 1. Field

The disclosure relates to a field of electronic technology. More particularly, the disclosure relates to methods, devices, and computer programs for displaying a user interface.

### 2. Description of Related Art

With the development of science and electronic technology, the number of applications installed in electronic terminals such as smart phones increases to meet various needs. In order to facilitate a user to manage and use an application program, the application program or functions of the application program in the electronic terminal may be represented in the form of an icon.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method for displaying a user interface.

Additional aspects will be set forth in part in the description which follows and, in part, will be apparent from the description, or may be learned by practice of the presented embodiments.

In accordance with an aspect of the disclosure, an electronic device is provided. The electronic device includes a memory storing instructions, and at least one processor configured to execute the instructions to display, in a partial area of a graphic user interface, a first graphic representation of a function in the electronic device, identify a value corresponding to the function in the electronic device, and display, in the partial area, a second graphic representation of the function based on the identified value, wherein the first graphic representation is different from the second graphic representation, and wherein a display of the first graphic representation and a display of the second graphic representation alternate with each other in the partial area in response to receiving one or more user inputs on the first graphic representation and the second graphic representation.

According to an embodiment, the second graphic representation comprises the identified value.

According to an embodiment, the first graphic representation of the function is displayed based on the function being switched off, and the second graphic representation of the function is displayed based on the function being switched on.

According to an embodiment, the at least one processor is further configured to execute the instructions to activate the function in response to receiving a user input on the first graphic representation, wherein the identified value corresponds to the activated function, and wherein the second graphic representation of the activated function is displayed based on the identified value.

According to an embodiment, the first graphic representation is displayed as a default icon of the function.

According to an embodiment, the identified value comprises an identified name of a device which is connected to the electronic device by the function.

According to an embodiment, the identified value comprises an identified number related to the function.

According to an embodiment, the identified number is related to a number when the function is switched on the last time.

According to an embodiment, the identified number is related to a number based on the function being switched off the last time.

According to an embodiment, the first graphic representation of the function is displayed based on the function being switched on, and the second graphic representation of the function is displayed when the function is switched off.

According to an embodiment, the at least one processor is further configured to execute the instructions to deactivate the function in response to receiving a user input on the first graphic representation, wherein the identified value corresponds to the deactivated function, and wherein the second graphic representation of the deactivated function is displayed based on the identified value.

According to an embodiment, the second graphic representation is displayed as a default icon of the function.

According to an embodiment, the function is related to at least one of Wi-Fi, Bluetooth, volume, cellular data, or a power saving mode.

According to an embodiment, value is identified in real-time or periodically.

According to an embodiment, the at least one processor is further configured to execute the instructions to display the graphic user interface in response to a user input starting from an edge of a display of the electronic device.

According to an embodiment, the function in the electronic device comprises an application in the electronic device, and the identified value represents resources of the electronic device used by the application in the electronic device.

According to an embodiment, the at least one processor is further configured to execute to execute the application in response to receiving a user input on the first graphic representation, the second graphic representation of the application being displayed in response to the identified value exceeding a threshold, and terminate the application in response to receiving a user input on the second graphic representation.

According to an embodiment, a gesture of the user input on the first graphic representation is different from a gesture of the user input on the second graphic representation.

In accordance with another aspect of the disclosure, a method is provided. The method includes displaying, in a partial area of a graphic user interface, a first graphic representation of a function in an electronic device, identifying a value corresponding to the function in the electronic device, and displaying, in the partial area, a second graphic representation of the function based on the identified value, wherein the first graphic representation is different from the second graphic representation, and wherein a display of the first graphic representation and a display of the second graphic representation alternate with each other in the partial area in response to receiving one or more user inputs on the first graphic representation and the second graphic representation.

In accordance with another aspect of the disclosure, a computer program is provided. The computer program includes a non-transitory computer readable recording medium having recorded thereon a plurality of instructions, which when executed by at least one processor, cause the at least one processor to perform the method above.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart of a method for displaying an icon in an electronic terminal according to an embodiment of the disclosure;

FIG. 2 is a block diagram of a device for displaying an icon in an electronic terminal according to an embodiment of the disclosure;

FIGS. 3A and 3B illustrate icons displayed in an electronic terminal according to various embodiments of the disclosure;

FIG. 4 is a flowchart of a method of displaying an icon according to an embodiment of the disclosure; and

FIG. 5 illustrates a home screen according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. The following description includes various specific details to assist in that understanding but these are to be regarded as merely exemplary. Accordingly, those of ordinary skill in the art will recognize that various changes and modifications of the various embodiments described herein may be made without departing from the scope of the disclosure as defined in the appended claims. In addition, descriptions of well-known functions and constructions may be omitted for clarity and conciseness.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the embodiments. Furthermore, the one or more elements may have been represented in the drawings by various symbols, and the drawings may show only those specific details that are pertinent to understanding the embodiments of the disclosure so as not to obscure the drawings with details that will be readily apparent to those of ordinary skill in the art having benefit of the description herein.

The terms and words used in the following description and claims are not limited to the bibliographical meanings, but, are merely used by the inventors to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. Additionally, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The terms “include” and “comprise,” as well as derivatives thereof, mean inclusion without limitation. The term “or,” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Moreover, various functions described below may be implemented or supported by one or more computer programs, each of which may be formed from computer readable program code and embodied in a computer readable medium. The terms “application”, “program”, and “application program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

The term “unit”, “manager”, “engine”, or “device” may refer to a unit which processes at least one function or operation and may be implemented by hardware, software, or a combination of hardware and software.

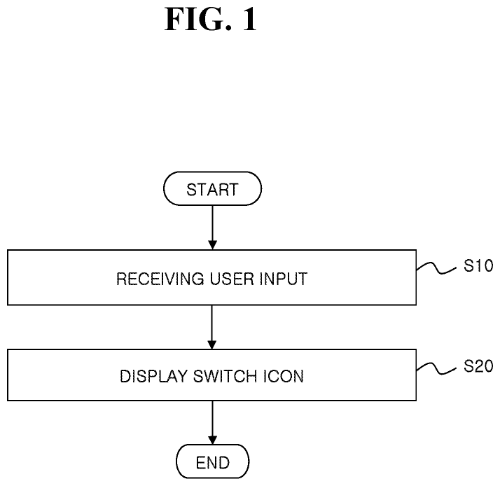

FIGS. 1, 2, 3A, 3B, 4, and 5 discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

According to an aspect of the disclosure, a method for displaying an icon in an electronic terminal is provided, and the method includes: receiving a predetermined user input; displaying a predetermined switch icon in response to receiving the predetermined user input, wherein, the displaying the predetermined switch icon includes: displaying as a predetermined switch icon a predetermined parameter of a function corresponding to the predetermined switch icon.

According to an embodiment, the displaying the predetermined switch icon includes: when the function corresponding to the predetermined switch icon is off state, displaying as the predetermined switch icon a default icon of the function; when the function corresponding to the predetermined switch icon is on state, displaying as the predetermined switch icon the predetermined parameter of the function.

According to an embodiment, the displaying the predetermined switch icon further includes: displaying a name of the function and/or text indicating on/off state of the function in vicinity of the predetermined switch icon.

According to an embodiment, the displaying the predetermined switch icon includes: displaying a quick switch panel including the predetermined switch icon.

According to an embodiment, a default icon of the function is a fixed image corresponding to the function, or the predetermined parameter when the function is switched to off state the last time.

According to an embodiment, the default icon is displayed in a first color or grayscale, the predetermined parameter of the function is displayed in a second color or grayscale.

According to an embodiment, when the predetermined switch icon is a Wi-Fi switch icon, the function corresponding to the Wi-Fi switch icon is Wi-Fi, the default icon of the Wi-Fi switch icon is a first fixed image, and the predetermined parameter of the Wi-Fi switch icon is a name of an access point accessed by the Wi-Fi.

According to an embodiment, when the predetermined switch icon is a volume switch icon, the function corresponding to the predetermined switch icon is a mute function, the default icon of the volume switch icon is the predetermined parameter when the mute function is switched to the off state the last time, and the predetermined parameter is a volume size of the electronic terminal.

According to an embodiment, when the default icon of the volume switch icon is displayed, a first text indicating that the electronic terminal is in mute state is displayed in vicinity of the volume switch icon; when the predetermined parameter of the volume switch icon is displayed, a second text indicating that the electronic terminal is in non-mute state is displayed in vicinity of the volume switch icon.

According to an embodiment, when the predetermined switch icon is a cellular data icon, the function corresponding to the predetermined switch icon is cellular data, the default icon of the cellular data icon is the predetermined parameter when the cellular data is switched to the off state the last time, and the predetermined parameter of the cellular data is: an amount of cellular data currently used by the electronic terminal or an amount of cellular data currently left for the electronic terminal.

According to an embodiment, when the predetermined switch icon is a Bluetooth switch icon, the function corresponding to the Bluetooth switch icon is Bluetooth, the default icon of the Bluetooth switch icon is a second fixed image, and the predetermined parameter of the Bluetooth switch icon is a name of a Bluetooth device accessed by the Bluetooth.

According to an embodiment, when the predetermined switch icon is a battery saving mode switch icon, the function corresponding to the battery saving mode switch icon is battery saving mode, the default icon of the battery saving mode switch icon is a third fixed image, and the predetermined parameter of the battery saving mode switch icon is a remaining running time of a battery of the electronic terminal.

According to an embodiment, when time of display of the predetermined switch icon exceeds a predetermined time, the predetermined parameter is updated in a predetermined period and displayed.

According to another aspect of the disclosure, a device for displaying an icon in an electronic terminal is provided, and the device includes: a user interface for receiving a predetermined user input; a display module for displaying a predetermined switch icon in response to receiving the predetermined user input, wherein the display module displays as a predetermined switch icon a predetermined parameter of a function corresponding to the predetermined switch icon.

In a method and a device for displaying an icon in an electronic terminal according to the disclosure, by displaying as a predetermined switch icon a predetermined parameter of a function corresponding to a predetermined switch icon, the number of inputs to obtain relevant information of the function corresponding to the predetermined switch icon decreases.

The icon may have a fixed shape, and its color may change to represent on/off state of the switch icon. When the user wants to obtain information about a function corresponding to the switch icon, the user often needs to enter additional inputs.

FIG. 1 illustrates a method for displaying an icon in an electronic terminal according to an embodiment. As an example, the electronic terminal may be a smart phone, a tablet, a personal computer, a personal digital assistant, a game console, etc. where applications can be installed, but is not limited thereto. The electronic terminal may be referred to as an electronic device.

An icon may be a graphic representation displayed in a graphic user interface or a part of the graphic representation, and a user may interact with the icon to perform a corresponding operation or function in the electronic terminal. In an embodiment, an icon may be a shortcut icon to a certain application, and icons of applications installed in the electronic terminal may be displayed on a home screen, a desktop screen, or an app launcher of the electronic terminal. In an embodiment, an icon may be a controller for controlling a certain function of the electronic terminal, and icons of various functions may be displayed on a control panel or a control center of the electronic terminal. The control panel may be displayed in response to a user input starting from an edge or side of a display of the electronic terminal, and an icon of activated function may be highlighted or represented as a different color than an icon of deactivated function.

Referring to FIG. 1, at an operation S10, a user input is received. The user input for displaying a predetermined switch icon may be predetermined. In an embodiment, when a user input is received at a predetermined location of a display of the electronic terminal (for example, a swipe input starting from an edge or a side of the display) is received, the predetermined switch icon may be displayed.

The predetermined user input may refer to a touch input received from a user for displaying a switch icon. For example, the predetermined touch input may be a double-tap input, a drag-and-drop input, a long-tap input, or a swipe input, but is not limited thereto.

In an embodiment, the predetermined switch icon may include Wi-Fi switch icon, a sound output switch icon, a cellular data switch icon, a Bluetooth switch icon, and a power saving mode switch icon, and etc., but is not limited thereto. The predetermined switch icon may represent a switch icon activating and deactivating a certain function. The certain function is switched on and off by a user input on the predetermined switch icon. The predetermined switch icon may have different looks according to activation of a corresponding function. For example, the predetermined switch icon may be displayed in a grey color when the corresponding function is deactivated. For example, the predetermined switch icon may be displayed in a brighter color when the corresponding function is activated.

At operation S20, a predetermined switch icon is displayed in response to receiving the predetermined user input. In an embodiment, when displaying the predetermined switch icon, a predetermined parameter of a function corresponding to the predetermined switch icon may be displayed as the predetermined switch icon. In an embodiment, the predetermined parameter may be obtained through a data interface of an application corresponding to the predetermined switch icon. In an embodiment, the predetermined switch icon may be included in a quick switch panel, such as a control panel or a control center. In an embodiment, the quick switch panel may be displayed as a drop-down menu of the electronic terminal.

In an embodiment, a value of the predetermined parameter may be displayed as the predetermined parameter. The value of the predetermined parameter may be identified or calculated by the electronic terminal.

In an embodiment, the predetermined switch icon may be displayed differently according to whether the function corresponding to the predetermined switch icon is in on state or off state. The function may be in on state when the function is activated. The function may be in off state when the function is deactivated. When the function corresponding to the predetermined switch icon is off state, a default icon of the function may be displayed as the predetermined switch icon; when the function corresponding to the predetermined switch icon is on state, the predetermined parameter of the function is displayed as the predetermined switch icon.

In an embodiment, a default icon of the function may be a fixed image corresponding to the corresponding function. For example, the fixed image may be understood as an image with no movement.

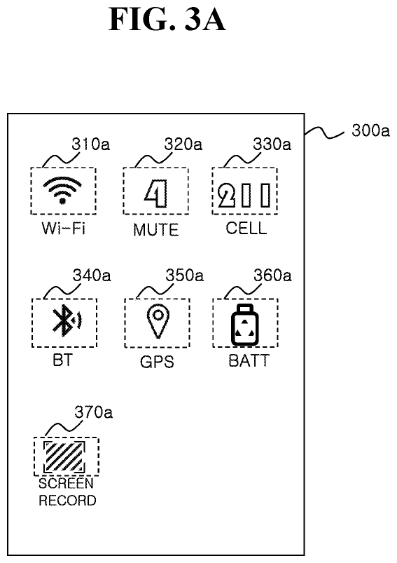

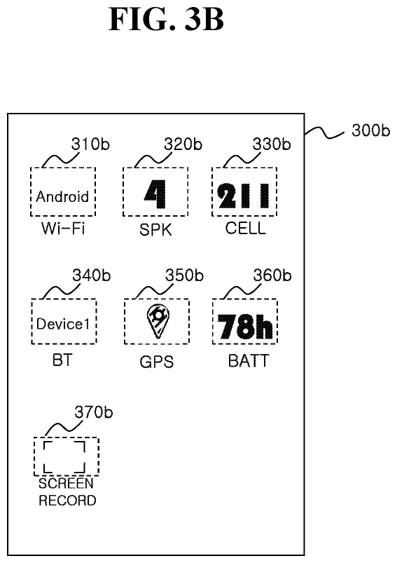

In an embodiment, when the predetermined switch icon is a Wi-Fi switch icon, the function corresponding to the Wi-Fi switch icon is a Wi-Fi function, the default icon of the Wi-Fi switch icon is a first fixed image, and the predetermined parameter of the Wi-Fi switch icon is a name of an access point being accessed by the Wi-Fi function. For example, the first fixed image may be a fixed image related to the Wi-Fi function (such as an icon 310a in FIG. 3A).

In an embodiment, when the predetermined switch icon is a Bluetooth switch icon, the function corresponding to the Bluetooth switch icon is a Bluetooth function, the default icon of the Bluetooth switch icon is a second fixed image, and the predetermined parameter of the Bluetooth switch icon is, for example, a name of a Bluetooth device being connected by the Bluetooth function. For example, the second fixed image may be a fixed image related to the Bluetooth function (such as an icon 340a in FIG. 3A).

In an embodiment, when the predetermined switch icon is a battery saving mode switch icon, the function corresponding to the battery saving mode switch icon is a battery saving function, the default icon of the battery saving mode switch icon is a third fixed image, and the predetermined parameter of the battery saving mode switch icon is a remaining running time of a battery of the electronic terminal. For example, the third fixed image may be a fixed image related to the power saving mode (such as an icon 360a in FIG. 3A).

In an embodiment, a default icon of the function may be the predetermined parameter when the function is switched to off state the last time.

In an embodiment, when the predetermined switch icon is a volume switch icon, the function corresponding to the predetermined switch icon is a mute function or a sound output function, the default icon of the volume switch icon (for example, an icon 320a in FIG. 3A) is the predetermined parameter when the mute function is switched off or the sound output function is switched on the last time, and an example of the predetermined parameter of the sound output function is a volume of a sound output of the electronic terminal. Here, the mute function is switched on, then the electronic terminal is in mute state. The mute function is switched on, then the electronic terminal is in non-mute state. It is noted that the default icon of the above volume switch is an example, and the default icon of the volume switch icon may be a combination of the predetermined parameter when the mute function is switched off the last time and a certain fixed image.

In an embodiment, when the predetermined switch icon is a cellular data icon, the function corresponding to the predetermined switch icon is a cellular data function, the default icon of the cellular data icon is the predetermined parameter when the cellular data function is switched to the off state the last time, and the predetermined parameter of the cellular data is, for example, an amount of cellular data currently used by the electronic terminal, an amount of cellular data currently left for the electronic terminal, etc., but is not limited thereto.

In addition, the predetermined parameter may be obtained in different ways according to an embodiment.

In an embodiment, the predetermined parameter of the function is obtained in real-time, and the obtained predetermined parameter is displayed as the predetermined switch icon. Here, obtaining the predetermined parameter in real-time may represent obtaining the predetermined parameter in response to the predetermined parameter being changed.

In another embodiment, the predetermined parameter of the function is obtained periodically, and the obtained predetermined parameter is displayed as the predetermined switch icon. Here, obtaining the predetermined parameter periodically may represent obtaining the predetermined parameter at a predetermined time interval. For example, the predetermined time interval may be set by a user or an electronic terminal.

According to an embodiment, in order to let a user know a current state of a function corresponding to the predetermined switch, a name or the current state of the corresponding function may be displayed in the vicinity of the predetermined switch icon.

In an embodiment, When the predetermined switch icon is a Wi-Fi switch icon, a name indicating a Wi-Fi network (for example, “Wi-Fi” as illustrated in FIG. 3A) may be displayed in the vicinity of the Wi-Fi switch icon (for example, below the Wi-Fi switch icon).

According to an embodiment, text indicating on/off state of the function in vicinity of the predetermined switch icon may be displayed. For example, when the default icon of the volume switch icon is displayed, a first text indicating that the electronic terminal is in mute state (for example, “MUTE”) may be displayed in vicinity of the volume switch icon for letting a user know a current state of a sound output function or a mute function. When the predetermined parameter of the sound output function (for example, a speaker volume) is displayed, a second text indicating that the electronic terminal is in non-mute state and the sound is output through a speaker (for example, “SPK” as illustrated in FIG. 3A) is displayed in vicinity of the volume switch icon, for example, below the volume switch icon.

The above description is provided as an example, and the display of a name of a function and a current state of a predetermined switch icon is not limited thereto.

According to an embodiment, the default icon may be displayed in a first color or grayscale, the predetermined parameter of the function may be displayed in a second color or grayscale for letting a user intuitively recognize a current state of the function. For example, the first color or grayscale may correspond to a gray color, and the second color or grayscale may correspond to a blue color. However, the disclosure is not limited thereto, and a different first color or grayscale and a different second color or grayscale may be applicable.

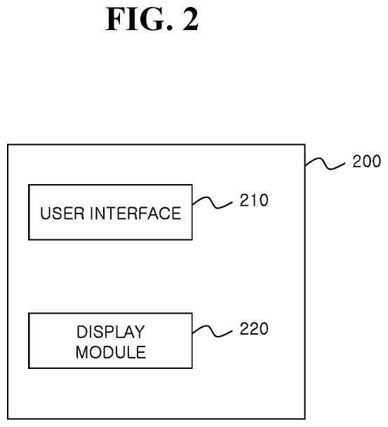

FIG. 2 illustrates a device 200 for displaying an icon in an electronic terminal according to an embodiment. The device 200 may be the electronic terminal but is not limited thereto. The device 200 may be a part of the electronic terminal.

Referring to FIG. 2, a device 200 includes a user interface 210 and a display module 220. The user interface 210 and the display module may be implemented as a software component but are not limited thereto. The user interface 210 receives a user input. The display module 220 displays a switch icon in response to the user interface 210 receiving the user input. The display module 220 displays as a predetermined switch icon a predetermined parameter of a function corresponding to the predetermined switch icon. For example, the display module 220 may obtain the predetermined parameter through a data interface of an application corresponding to the predetermined switch icon. In an embodiment, the display module 220 may display a quick switch panel including the predetermined switch icon. For example, the quick switch panel may be a drop-down menu of the electronic terminal. In an embodiment, the device 200 may be a device configured to execute any method explained with FIG. 1, and any method and operation explained with FIG. 1 may be executed by the device 200.

Here, the predetermined parameter may be value, data or information related to the function corresponding to the switch icon.

In an embodiment, the display module 220 may display the predetermined switch icon differently according to whether the function corresponding to the predetermined switch icon is in on state or off state. In an embodiment, when the function corresponding to the predetermined switch icon is off state, the display module 220 may display a default icon of the function as the predetermined switch icon. In an embodiment, when the function corresponding to the predetermined switch icon is on state, the display module 220 may display in real-time the predetermined parameter of the function instead of the predetermined switch icon.

In an embodiment, the default icons of predetermined switch icons and the predetermined parameters of the corresponding functions are described as above by referring to FIG. 1, and abundant explanation is omitted for the sake of simplicity. Explanation of the default icons of predetermined switch icons and the predetermined parameters of the corresponding functions in FIG. 1 is also applicable to FIG. 2. In addition, the display module 220 may obtain the predetermined parameter in different ways according to an embodiment.

In an embodiment, the display module 220 may obtain the predetermined parameter of the function in real-time, and the obtained predetermined parameter is displayed as the predetermined switch icon. Here, obtaining the predetermined parameter in real-time may represent obtaining the predetermined parameter when the predetermined parameter changes. For example, when an amount of change of the predetermined parameter is greater than a threshold amount, the predetermined parameter may be considered to be changed. The threshold amount may be set by a user or an electronic terminal.

In an embodiment, the display module 220 may obtain the predetermined parameter of the function periodically, and the obtained predetermined parameter is displayed as the predetermined switch icon. Here, obtaining the predetermined parameter periodically may represent obtaining the predetermined parameter at a predetermined time interval. For example, the predetermined time interval may be set by a user or an electronic terminal.

According to an embodiment, in order to let a user understand a function corresponding to the predetermined switch, the display module 220 may display a name or a current state of the corresponding function in the vicinity of the predetermined switch icon.

In an embodiment, when the predetermined switch icon is a Wi-Fi switch icon, the display module 220 may display a name indicating a Wi-Fi function (for example, “Wi-Fi” in FIG. 3A) in the vicinity of the Wi-Fi switch icon (for example, below the Wi-Fi switch icon).

According to an embodiment, the display module 220 may display text indicating on/off state of the function in vicinity of the predetermined switch icon. For example, when the default icon of the volume switch icon is displayed, the display module 220 may display a first text indicating that the electronic terminal is in mute state (for example, “MUTE”) in vicinity of the volume switch icon for allowing a user to understand the volume switch icon. When the predetermined parameter of a sound output function (for example, a speaker volume) is displayed, the display module 220 may display a second text indicating that the electronic terminal is in non-mute state and the sound is output through a speaker (for example, “SPK” as illustrated in FIG. 3A) in vicinity of the volume switch icon, for example, below the volume switch icon. The above description is provided as an example, and a display way of a function's name of other types of predetermined switch icon in the display module 220 is not limited thereto.

According to an embodiment, the display module may display the default icon in a first color or grayscale, the predetermined parameter of the function may be displayed in a second color or grayscale for intuitive recognition of a user. For example, the first color or grayscale may correspond to a gray color, and the second color or grayscale may correspond to a blue color. However, the disclosure is not limited thereto, and a different first color or grayscale and a different second color or grayscale may be applicable.

FIG. 3A and FIG. 3B illustrate icons displayed in an electronic terminal according to an embodiment. In an embodiment, icons may correspond to functions of the electronic terminal, and the icons may be included in a control center 300a. The control center 300a may be displayed as a drop-down menu but is not limited thereto. The control center 300a may be displayed in response to a swipe-down from a side or an edge of the electronic terminal.

Referring to FIG. 3A, a switch icon 370a corresponding to a screen record function may be included in the control center 300a. The screen record function is in on state and the switch icon 370a is illustrated in FIG. 3A as being highlighted. Other switch icons (for example, an icon 310a corresponding to a Wi-Fi function, a switch icon 320a corresponding to a mute function or a sound output function, a switch icon 330a corresponding to a cellular data function, a switch icon 340a corresponding to a Bluetooth function, a switch icon 350a corresponding to a geographic positioning system (GPS) function, a switch icon 360a corresponding to a power saving mode) are illustrated in FIG. 3A as being in off-state. In an embodiment, as the switch icon 320a corresponding to the sound output function, a parameter (for example, “4” of volume) when the sound output function is switched on the last time may be displayed. In an embodiment, as the switch icon 330a, a parameter (for example, “211” of used cellular data or remaining cellular data) when a cellular data function is switched off the last time is displayed. That is, the used cellular data or remaining cellular data has not increased or decreased because the cellular data function was switched off the last time and not switched on thereafter.

FIG. 3B illustrates switch icons of FIG. 3A switched on.

Referring to FIG. 3B, the control center 300b includes switch icons 310b, 320b, 330b, 340b, 350b, and 360b whose corresponding functions are switched on, and a switch icon 370b whose corresponding function is switched off.

Referring to FIG. 3B, the switch icon 310b corresponding to a Wi-Fi function is switched on, that is, the Wi-Fi function is switched on, then a name of an access point (such as “Android”) accessed by the electronic terminal is displayed.

The switch icon 320b corresponding to a sound output function is switched on, that is, the sound output function is switched on, then current speaker volume (such as 4) of the electronic terminal is displayed. Further, “SPK” is displayed instead of “MUTE” below the switch icon 320b to indicate a speaker is used to output sound. When an earphone or a Bluetooth earphone is connected to the electronic terminal and used to output sound, then, a name of the earphone or the Bluetooth earphone may be displayed instead of “SPK”

The switch icon 330b corresponding to the cellular data function is switched on, that is, the cellular data function is switched on, then a currently used cellular data or remaining cellular data (such as “211”) is displayed. An icon of activated function may be highlighted or represented as a different color than an icon of deactivated function. For example, referring to FIG. 3B, a parameter corresponding to a function, such as, a sound output function, may be displayed in a highlight while the sound output function is in on state.

The switch icon 340b corresponding to a Bluetooth function is switched on, that is, the Bluetooth function is switched on, then a name of a Bluetooth device (such as “Device 1”) connected to the electronic terminal may be displayed.

The switch icon 350b corresponding to a GPS function is switched on, that is, the GPS function is switched on, then the switch icon 350b is displayed in a color different from one when it is in off state.

The switch icon 360b corresponding to power saving mode is switched on, that is, the power saving mode is switched on, then remaining battery time (such as “78 h”) of the electronic terminal is displayed. The remaining battery time may be displayed in a highlight to indicate that the power saving mode is in on state.

The switch icon 370b corresponding to a screen record is illustrated in FIG. 3B as being switched off.

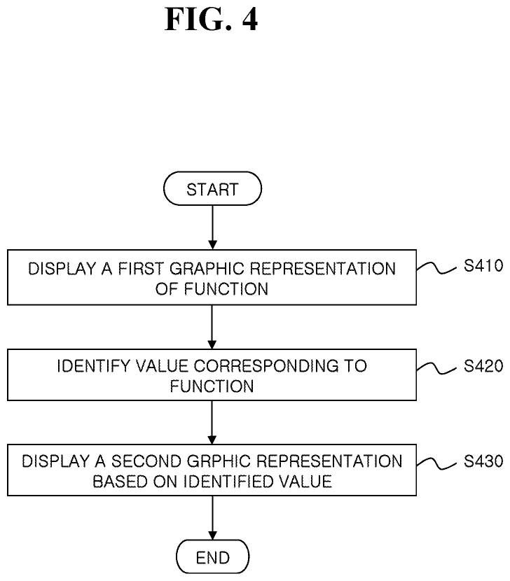

FIG. 4 is a flowchart of a method of displaying an icon according to an embodiment.

Referring to FIG. 4, at operation S410, a first graphic representation of a function is displayed on a display of an electronic device. The first graphic representation may be displayed in a partial area of a graphic user interface. The graphic representation may include an icon of a function or an application and a text related to the function or the application.

At operation S420, a value corresponding to the function is identified. The value corresponding to the function may be a value of a parameter corresponding to the function.

At operation S430, a second graphic representation is displayed based on the identified value. The second graphic representation may be displayed in the same partial area of the graphic user interface.

In an embodiment, the first and second graphic representations may be different from each other. For example, the first graphic representation of a function includes a display of an icon of the function while the second graphic representation of the function includes a display of an identified value corresponding to the function.

In an embodiment, a display of the first graphic representation and a display of the second graphic representation alternate with each other in the partial area as the corresponding function is switched on and off.

In an embodiment, the function may be an application installed in the electronic device, and the graphic representation of the function may include an icon of the application. A value corresponding to the function may represent resources of the electronic device used by the application running in the electronic device. A first graphic representation of the application may be displayed in the electronic device when the application is not running in the electronic device. When the application is running in background of the electronic device and using resources of the electronic device more than a threshold or relatively more than other applications, a second graphic representation of the application may be displayed instead of the first graphic representation. In response to a user input on the second graphic representation, such as a long tap on the second graphic representation, the application may be terminated to free the resources which has been used by the application.

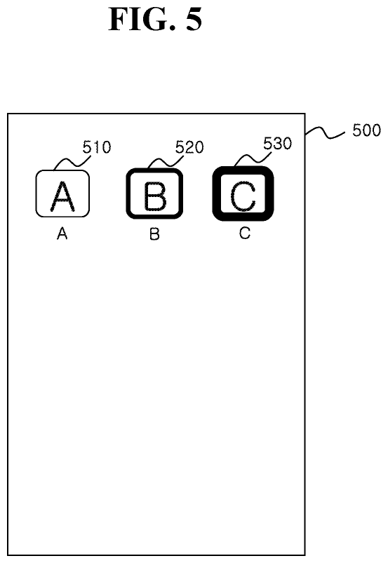

FIG. 5 illustrates a home screen according to an embodiment.

Referring to FIG. 5, the home screen 500 includes icons 510, 520, and 530 of applications “A”, “B”, and “C”.

An icon 510 of an application “A” represents an icon of an application which is not running in background of the electronic device.

An icon 520 of an application “B” represents an icon of an application which is running in background of the electronic device. The icon 520 is illustrated as having a thicker outline than the icon 510 to indicate that the application “B” is running in background of the electronic device but is not limited thereto. For example, the icon 520 of the application “B” running in background may have an outline with a different color than the icon 510, or a title of the application “B” may have a different color than a title of the application “B”.

An icon 530 of an application “C” represents an icon of an application which is running in background of the electronic device and using resources of the electronic device more than a threshold or other applications. The icon 530 is illustrated as having a thicker outline than the icons 510 and 520 to indicate that the application “C” is running in background of the electronic device and using resources more than a threshold or other applications but is not limited thereto. For example, the icon 530 of the application “C” may have an outline with a different color than the icons 520 and 530, or a title of the application “C” may have a different color than titles of the applications “A” and “B”.

In an embodiment, thickness of an outline of an icon of the application may vary based on an amount of resources used by an application. For example, the outline of the icon of the application may be thicker as an amount of resources used by the application increases.

In an embodiment, a color of an outline of an icon of the application may vary based on an amount of resources used by an application. In an embodiment, a color of title of the application may vary based on an amount of resources used by an application.

In an embodiment, the same user input may trigger different actions according to a state, or an appearance of an icon. For example, when a user input, such as a long tap, is received on an icon of an application which is not running in the electronic device, a menu for editing the icon of the application may be displayed, and when the same user input is received on icon of an application which is running in background of the electronic device using resources of the electronic device more than a threshold or more than average usage of other applications, the application is terminated to have more resources for other applications. According to an embodiment, an application may be terminated selectively and conveniently according to an amount of resources used by the application.

The above embodiments may be applied to a desktop or an app launcher including icons of applications.

According to an embodiment, a computer readable storage medium storing a computer program is further provided. The computer readable storage medium stores a computer program that, when executed by a processor, causes the processor to execute a method of displaying an icon in an electronic terminal. The computer readable storage medium is any data storage device that can store data which is read by a computer system. Examples of the computer readable storage medium includes: a read only memory (ROM), a random access memory (RAM), a read-only optical disc, a magnetic tape, a floppy disk, an optical data storage device, and a carrier wave. A computer program product may be the computer readable storage medium, but is not limited thereto.

In a method and a device for displaying an icon in an electronic terminal according to the disclosure, by displaying as a predetermined switch icon a predetermined parameter of a function corresponding to a predetermined switch icon, the number of inputs to obtain relevant information of the function corresponding to the predetermined switch icon decreases, thus, user experience may be enhanced.

An electronic terminal may include a processor and a memory. The memory stores a computer program, and when the computer program is executed by the processor, methods of displaying an icon described in the above may be carried out. A computer program product may be the electronic terminal, but not limited thereto.

Moreover, it should be understood that various units according to an embodiment may be implemented as hardware components and/or software components. Those skilled in the art can implement the various units, for example, using a Field Programmable Gate Array (FPGA) or an Application Specific Integrated Circuit (ASIC), depending on the processing performed by the various defined units.

Further, embodiments may be implemented as computer codes in a computer readable recording medium by those skilled in the art according to the disclosure. The computer codes are carried out when the computer codes are executed in a computer.

Although the disclosure has been described with various embodiments, various changes and modifications may be suggested to one skilled in the art. It is intended that the disclosure encompass such changes and modifications as fall within the scope of the appended claims.

What is claimed is:

1. An electronic device comprising:
a memory storing instructions; and
at least one processor configured to execute the instructions to:
display, in a partial area of a graphic user interface, a first graphic representation of a function in the electronic device,
identify a value corresponding to the function in the electronic device, and
display, in the partial area, a second graphic representation of the function based on the identified value,
wherein the first graphic representation is different from the second graphic representation, and
wherein a display of the first graphic representation and a display of the second graphic representation alternate with each other in the partial area in response to receiving one or more user inputs on the first graphic representation and the second graphic representation.

2. The electronic device of claim 1, wherein the second graphic representation comprises the identified value.

3. The electronic device of claim 1,
wherein the first graphic representation of the function is displayed based on the function being switched off, and
wherein the second graphic representation of the function is displayed based on the function being switched on.

4. The electronic device of claim 3,
wherein the at least one processor is further configured to execute the instructions to activate the function in response to receiving a user input on the first graphic representation,
wherein the identified value corresponds to the activated function, and
wherein the second graphic representation of the activated function is displayed based on the identified value.

5. The electronic device of claim 4, wherein the first graphic representation is displayed as a default icon of the function.

6. The electronic device of claim 1, wherein the identified value comprises an identified name of a device which is connected to the electronic device by the function.

7. The electronic device of claim 1, wherein the identified value comprises an identified number related to the function.

8. The electronic device of claim 7, wherein the identified number is related to a number based on the function being switched on last time.

9. The electronic device of claim 7, wherein the identified number is related to a number based on the function being switched off last time.

10. The electronic device of claim 1,
wherein the first graphic representation of the function is displayed based on the function being switched on, and
wherein the second graphic representation of the function is displayed based on the function being switched off.

11. The electronic device of claim 10,
wherein the at least one processor is further configured to execute the instructions to deactivate the function in response to receiving a user input on the first graphic representation,
wherein the identified value corresponds to the deactivated function, and
wherein the second graphic representation of the deactivated function is displayed based on the identified value.

12. The electronic device of claim 11, wherein the second graphic representation is displayed as a default icon of the function.

13. The electronic device of claim 1, wherein the function is related to at least one of Wi-Fi, Bluetooth, volume, cellular data, or a power saving mode.

14. The electronic device of claim 1, wherein the value is identified in real-time or periodically.

15. The electronic device of claim 1, wherein the at least one processor is further configured to execute the instructions to:
display the graphic user interface in response to a user input starting from an edge of a display of the electronic device.

16. The electronic device of claim 1,
wherein the function in the electronic device comprises an application in the electronic device, and
wherein the identified value represents resources of the electronic device used by the application in the electronic device.

17. The electronic device of claim 16, wherein the at least one processor is further configured to execute to:
execute the application in response to receiving a user input on the first graphic representation, the second graphic representation of the application being displayed in response to the identified value exceeding a threshold; and
terminate the application in response to receiving a user input on the second graphic representation.

18. The electronic device of claim 16, wherein a gesture of a user input on the first graphic representation is different from a gesture of a user input on the second graphic representation.

19. A method comprising:
displaying, in a partial area of a graphic user interface, a first graphic representation of a function in an electronic device;
identifying a value corresponding to the function in the electronic device; and
displaying, in the partial area, a second graphic representation of the function based on the identified value,
wherein the first graphic representation is different from the second graphic representation, and
wherein a display of the first graphic representation and a display of the second graphic representation alternate with each other in the partial area in response to receiving one or more user inputs on the first graphic representation and the second graphic representation.

20. A computer program product comprising a non-transitory computer readable recording medium having recorded thereon a plurality of instructions, which when executed by at least one processor, instruct the at least one processor to perform the method of claim 19.
